(19) United States
(12) Patent Application Publication
(10) Pub. No.: US 2018/0247258 A1
(43) Pub. Date: Aug. 30, 2018

(54) OPERATING SYSTEM FOR ON-DEMAND ECONOMY

(71) Applicant: DAIS TECHNOLOGY, INC., Glenview, IL (US)

(72) Inventors: Jason Kolb, Glenview, IL (US); Aaron Larson, Ankeny, IA (US); Jeremy Kolb, Chicago, IL (US)

(21) Appl. No.: 15/908,284

(22) Filed: Feb. 28, 2018

Related U.S. Application Data
(60) Provisional application No. 62/464,716, filed on Feb. 28, 2017.

(51) Int. Cl. G06Q 10/08; G06Q 10/10; G06Q 30/02; G06Q 50/28

(52) U.S. Cl. CPC G06Q 10/087; G06Q 10/0838; G06Q 50/28; G06Q 30/0206; G06Q 10/10

(57) ABSTRACT

An on-demand economy operating system is provided. The system matches supply and demand in products and services based on provider-shared supply data and operational system-determined demand data. Quotes, purchase agreements, bills and payments are seamlessly generated and published between participants in the on-demand economy, such as via a blockchain. The system provides continuous analysis and utilizes resulting success metrics to further improve efficiencies of the system. Methods and machine readable media are also provided.

### CROSS-REFERENCE TO RELATED APPLICATIONS

This application claims the benefit of U.S. Provisional Patent Application No. 62/464,716, filed Feb. 28, 2017, which is expressly incorporated herein by reference and made a part hereof.

### TECHNICAL FIELD

The present disclosure relates generally to operating systems, and more specifically to operating systems that analyze provider-shared supply data and operational system-determined demand data.

### BACKGROUND

The business world today, including buying and selling entities, has many inefficiencies involving supply and demand through the execution of transactions. For example, many entities in the supply chain do not run systems that speak a common language or have common processes. This results in inefficient matching of supply and demand, leading to such situations as oversupply (e.g., glut of products), shortages and sub-optimal product or service matches with relation to consuming entities desires or needs. Thus, mismatched, less efficient and more expensive outcomes are experienced by everyone involved.

It is desired to provide a system that efficiently matches supply and demand by analyzing and utilizing provider-shared supply data and operational system-determined demand data.

The description provided in the background section should not be assumed to be prior art merely because it is mentioned in or associated with the background section. The background section may include information that describes one or more aspects of the subject technology.

### SUMMARY

According to certain aspects of the present disclosure, a computer-implemented method for matching supply and demand in an on-demand economy is provided. In one or more embodiments, the method comprises obtaining operational data and operational profile inputs; determining at least one driver for generating leads based on the operational data and operational profile inputs; generating at least one lead; matching demand based on the at least one lead to one or more suppliers; creating a quote covering a product or service; delivering the quote to a device of a user; generating a purchase agreement and a payment agreement upon acceptance of the quote; measuring efficacy of the above process; and generating efficacy data to be used in a next iteration of matching demand to suppliers

According to certain aspects of the present disclosure, an on-demand economy operating system for efficiently matching supply and demand is provided. The system comprises an operational software module configured to provide an interface to one or more user devices; a supplier module configured to provide an interface to one or more supplier devices; a demand identification service module configured to identify needs in operational data; an exchange service module configured to catalogue supply, negotiate purchase agreements and negotiate bills; a demand matching service module configured to incorporate leads from the demand identification service module, to incorporate pricing and inventory information from the exchange service module, and to match supply with demand; and a data sharing service module configured to track user agreements and to share data with third parties

According to certain aspects of the present disclosure, on-demand economy operating system is provided. The system comprises a memory; and a processor configured to execute instructions which, when executed, cause the processor to obtain operational data and operational profile inputs; determine at least one driver for generating leads based on the operational data and operational profile inputs; generate at least one lead; match demand based on the at least one lead to one or more suppliers; create a quote covering a product or service; deliver the quote to a device of a user; generate a purchase agreement and a payment agreement upon acceptance of the quote; determine efficacy of the above process; and generate efficacy data to be used in a next iteration of matching demand to suppliers.

It is understood that other configurations of the subject technology will become readily apparent to those skilled in the art from the following detailed description, wherein various configurations of the subject technology are shown and described by way of illustration. As will be realized, the subject technology is capable of other and different configurations, and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for providing an on-demand economy operating system.

FIG. 2 is a block diagram illustrating an example client and server from the architecture of FIG. 1 according to certain aspects of the disclosure.

FIG. 3 illustrates an on-demand economy workflow schema provided by one or more embodiments of an on-demand economy operating system.

FIG. 4 illustrates an on-demand economy workflow schema provided by one or more embodiments of an on-demand economy operating system.

FIG. 5 illustrates an on-demand economy workflow schema provided by one or more embodiments of an on-demand economy operating system.

FIG. 6 illustrates an example data privacy selection screen.

FIG. 7 illustrates an example data set sharing selection screen.

FIG. 8 illustrates an example data flow schema provided by one or more embodiments of an on-demand economy operating system.

FIGS. 9A-9B is an example process associated with the disclosure of FIG. 2.

FIG. 10 is an example process associated with the disclosure of FIG. 2.

FIGS. 11A-11B is an example process associated with the disclosure of FIG. 2.

FIG. 12 is an example process associated with the disclosure of FIG. 2.

FIG. 13 is an example process associated with the disclosure of FIG. 2.

FIG. 14 is a block diagram illustrating an example computer system with which the clients and server of FIG. 2 can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

### General Overview

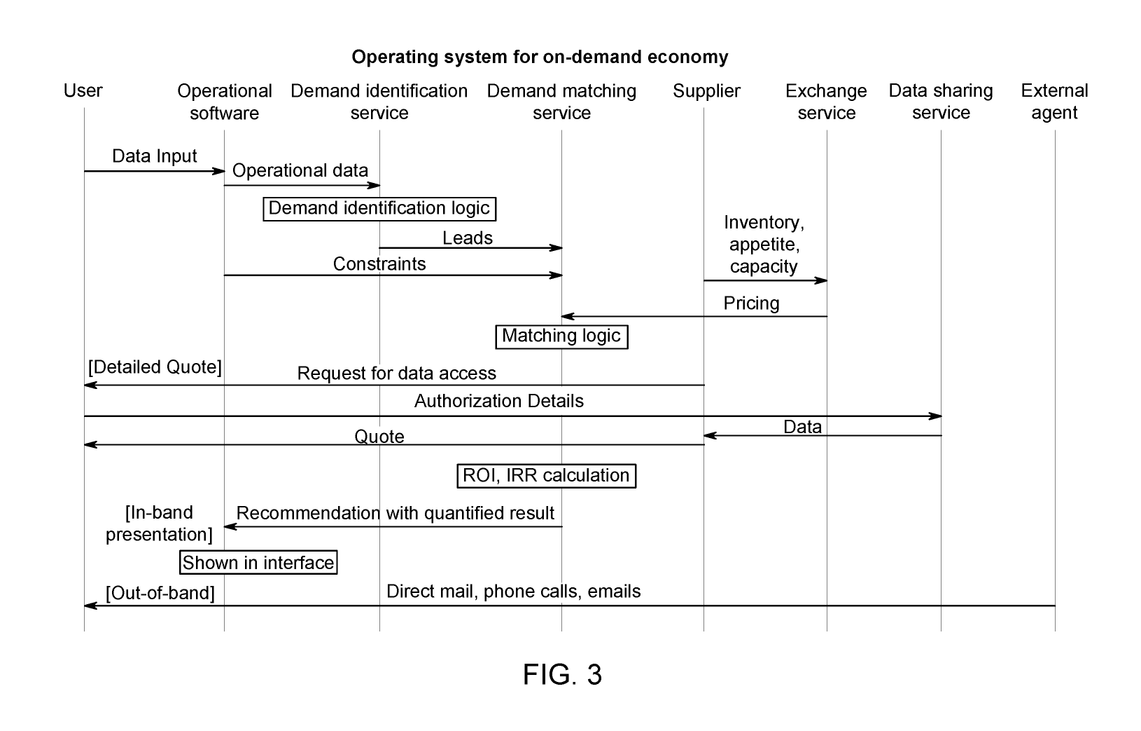

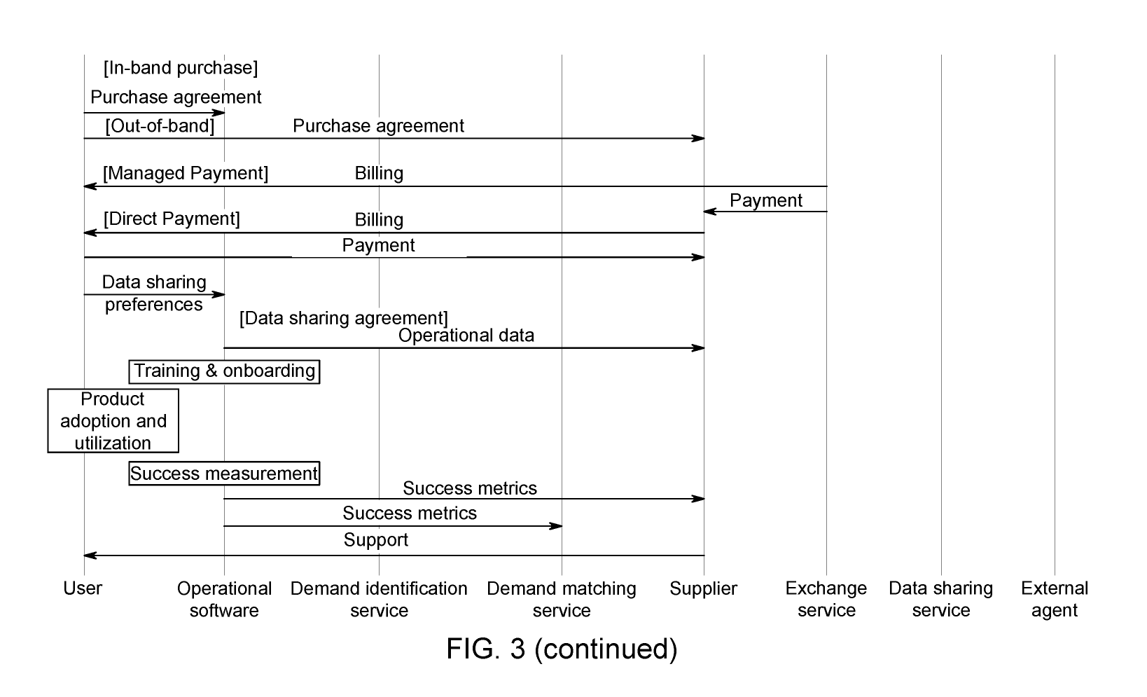

FIG. 3 illustrates an example workflow of an operating system for an on-demand economy. Here, the operating system provides touchpoints for several entities that vastly improve the efficiency of the on-demand economy. For example, users, operational software, a demand identification service, a demand matching service, suppliers, an exchange service, a data sharing service and external agents all have touchpoints or interactions with at least one process in the operating system.

In various embodiments, the user may provide data input, authorization details, in-band purchase agreements, out-of-band purchase agreements, and data sharing preferences, among other user provided materials. The user may also receive requests for data access, quotes, out-of-band communications (e.g., direct mail, phone calls, emails), billing (e.g., managed payment, direct payment) and support, among other requests. In various embodiments, the operational software may receive data input, in-band purchase agreements and data sharing preferences from the user, as well as recommendations with quantified results from the demand matching service. Further, in various embodiments the operational software may generate and/or transmit operational data to the demand identification service, constraints and/or success metrics to the demand matching service, and operation data and success metrics to the supplier.

In various embodiments, the demand identification service may receive the operational data from the operational software and generate and/or transmit leads to the demand matching service. The demand matching service may receive the leads from the demand identification service, constraints and success metrics from the operational software, and pricing from the exchange service. The demand matching service may generate and/or transmit recommendations with quantified results to the operational software. In addition, the supplier may receive out-of-band purchase agreements and payments from users, operational data and success metrics from the operational software, payments from the exchange service and data from the data sharing service. The supplier may generate and/or transmit requests for data access, quotes, billing and support to the users, as well as information (e.g., inventory, appetite, capacity) to the exchange service.

In various embodiments, the exchange service may receive the inventory, appetite, capacity information from the suppliers, as well as generate/transmit payment to the suppliers. The exchange service may also generate/transmit pricing to the demand matching service and direct payment billing to the users. The data sharing service may receive the authorization details from the users and generate/transmit data to the suppliers. In addition, the external agents may generate/transmit out-of-band communications to the users.

In various embodiments, as illustrated in FIG. 3, users may provide product adoption and utilization, while the operational software may by shown in a user interface and may provide training, onboarding and success measurement. The demand identification service may provide and/or utilize demand identification logic. Further, the demand matching service may provide and/or utilize matching logic, return on investment (ROI) calculations, and internal rate of return (IRR) calculations.

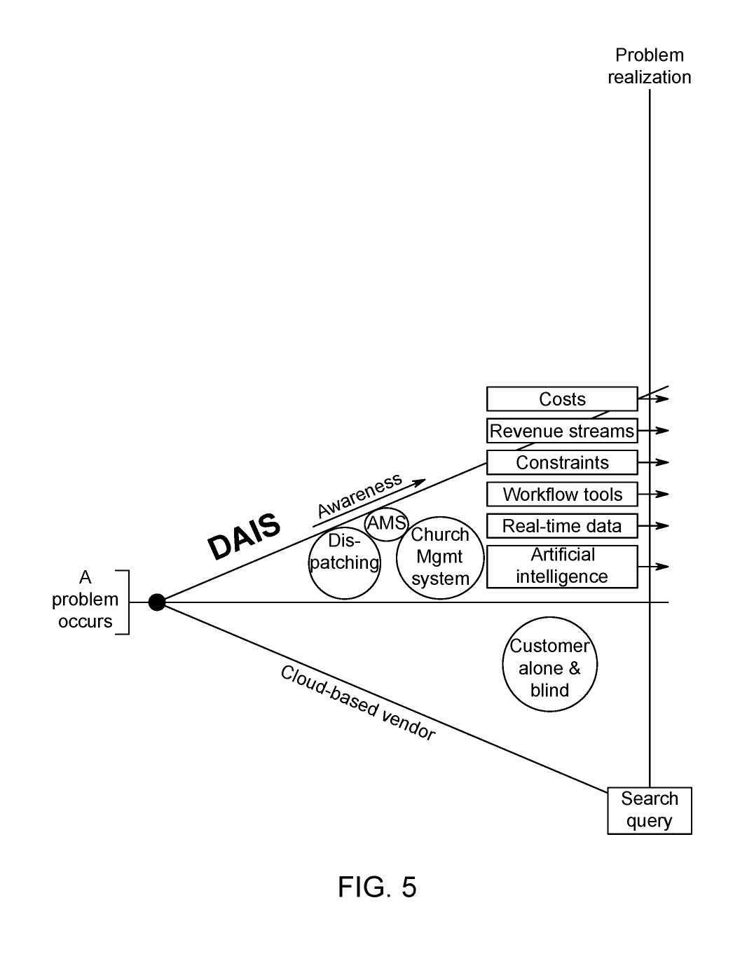

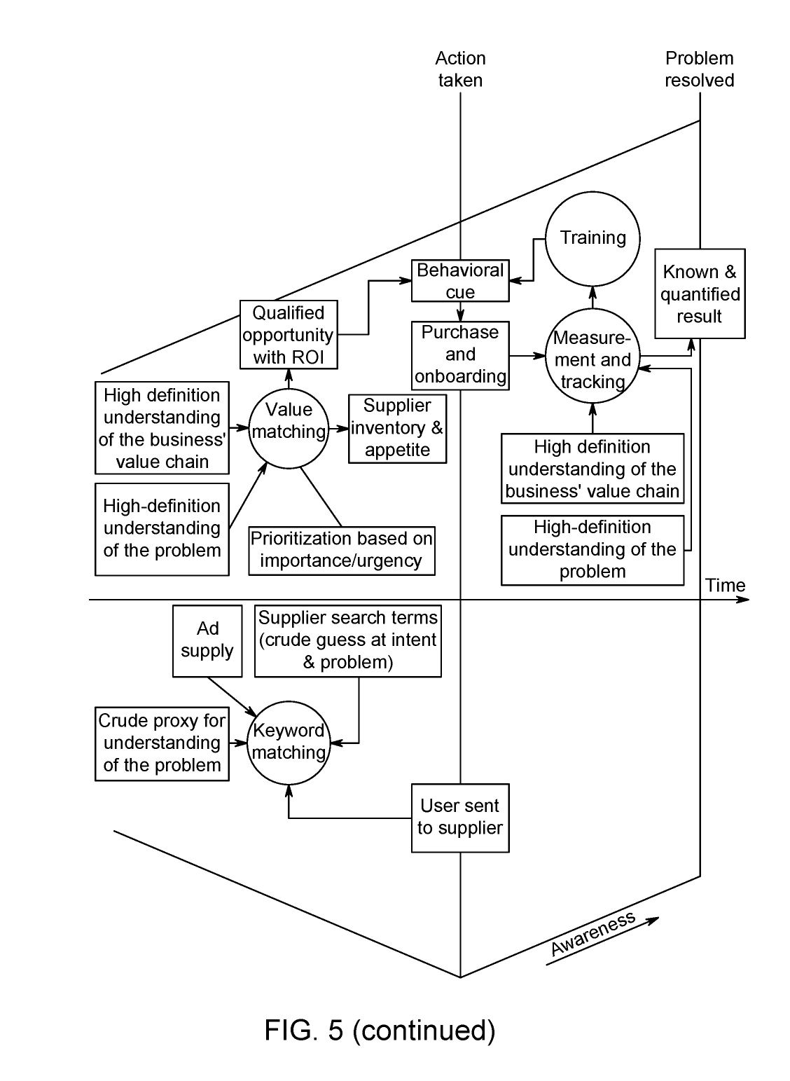

As further shown in FIGS. 3-8, in some implementations of the system a user inputs operational data via operational software. The operational data is then sent to, or received by, a demand identification service, and these terms will be described below in greater detail. Users interact with the operational software in the course of their employment, leisure activities, academic studies, research or other facets of their lives. Operational data may include, but is not limited to, customers, employees, equipment, facilities, orders, inventory and/or activities.

The operational software enables the user to accomplish a given task. In some aspects, the operational software enables the completion, furtherance or analysis of scheduling, dispatching, accounting, human resource matters, business command centers (such as resources coordination, visibility and optimization), business IT security, computers, mobile devices, device management and maintenance, sales management, equipment maintenance, job management and training. In some aspects, the operational software is capable of storing and calculating constraints including, but not limited to, capacity limitations (for entities such as people, space, equipment, facilities, spoilage or windows), waste drivers such as idling and spoilage, and growth limitations such as a lack of new business developments.

The demand identification service identifies needs in operational data, resulting in the generation of leads. In various embodiments, the identification can occur in a batch process or in a streaming event-driven process, for example ingesting operational data from an enterprise service bus. The demand identification service identifies and extracts needs from the operational data, and in some implementations includes industry best practices created by analyzing top performers or created by industry experts, and also includes a function that monitors incoming operational data and accordingly creates an aggregate view of business within a sliding window of time. In some implementations, the demand identification service includes, but is not limited to, a business classification system, determined through clustering algorithms and machine learning, which groups businesses into categories based on their value chain identified with a proprietary value assessment and business intake, a proprietary product adoption and utilization analysis, numbers of employees, location, industry, revenue streams, supply chain partners and their behavior trends, employee behaviors, software suite similarities, SIC or industry codes, customer base and/or product offerings.

The demand identification service creates leads in several ways including, but not limited to, running simulations to determine whether there are enough resources to meet constraints collected by the operational software, predicting demand using linear regression or other algorithms to determine whether the user should increase capacity, comparing the user's metrics against peer and industry benchmarks and thus identifying areas of potential improvement and comparing user activity against industry best practices. Further, in some implementations, the demand identification service creates leads by comparing spending against known pricing to identify areas for cost savings and by comparing inventory and capacity against known demand from other organizations to identify buyers for the user's products or services.

In some implementations, a demand exchange service publishes supplier inventory and pricing incorporating a blockchain. The demand exchange service catalogs supply and negotiates purchase agreements and billing, and can also analyze lead supply and make pricing or appetite recommendations to suppliers to increase profits or an addressable market. The demand exchange service can also publish purchase agreements, on a blockchain for example, and service the agreements by initiating billing. A supplier provides products and services, and further provides descriptions of those products and services in a known language, scheme or system and publishes the descriptions, including pricing, to the demand exchange service.

Leads and constraints, in some implementations of the present disclosure, are sent to the demand matching service, which matches supply with pricing and inventory from suppliers from the exchange service. Such matching can include prioritization by specific constraints on the demand side (such as time sensitivity) and capabilities on the supply side (such as time until delivery), prioritization to save the most money for the customer, prioritization to make the most money for the supplier, or prioritization by complex smart contracts such as Return On Investment (ROI) or Internal Rate of Return (IRR) for the customer over a given period of time. A demand matching service may take leads from the demand identification service, pricing and inventory from the exchange service and matches demand (leads) with supply (which can be represented as pricing+inventory). The matching service further develops a business graph that coordinates workflows with solutions and between parties.

A more detailed quote can be created for one or more suppliers, either before or after generating leads or during prioritization, by giving the suppliers detailed operational data about the user and the user's organization. If the user has not set their preferences to allow operational data sharing, the supplier or the exchange service can send a request to the user to share the operational data. The user can accept or decline this request, and may also opt to share a limited subset of operational data with a particular party. If the user agrees to share the operational data, such an agreement can be published on a blockchain. An operational data sharing and security service sees the agreement and facilities the operational data sharing process, as detailed below. Upon receiving the operational data, the supplier is able to apply their own pricing algorithms to create a customized quote for the user. The operational data sharing and security service tracks user agreements to share operational data with third parties, including suppliers, and mediates the delivery of operational data for activities such as quoting.

The demand matching service calculates return metrics including ROI, IRR, Net Present Value (NPV) and/or payback period for the user based on variables, such as product, need and pricing. In some implementations, recommendations for purchase, including product, supplier, return metrics, and purchase agreement, are presented to the end user in one of three ways. First, an “in-band delivery” method involves the demand matching service delivering the recommendation with quantified results to the operational software to be shown in an interface. One way this can be implemented is to vary the size and location within a screen of the interface, picture, font and/or recommendation. Second, an “out-of-band delivery” method involves the demand matching service delivering a recommendation directly to a user via direct mail, telephone and/or email, or similar communication methods. Third, a “third party” method involves the demand matching service sending a third party, such as an agent or broker, a message (using text, voice, fax, email, or similar electronic means) for them to present to the user directly using any communication method.

In some implementations, a purchase agreement is generated in one of two ways. First, the operational software may present the purchase agreement to the user, and then send the agreement details to the exchange service. This may be implemented by a “fix the problem now” or “buy the solution now” button. The buttons allow the user to instantly accept the purchase agreement and buy the solution using a predefined set of user parameters. Second, the supplier and user can form the agreement in person or via any electronic communication method.

Payment and billing can be handled in one of two ways. First, the exchange service can bill the user and generate payment for the end user. Second, the supplier can bill the user and the user can pay the supplier directly. The user can agree to supply the supplier with operational data in an ongoing relationship, and such an agreement can be managed from within the operational software.

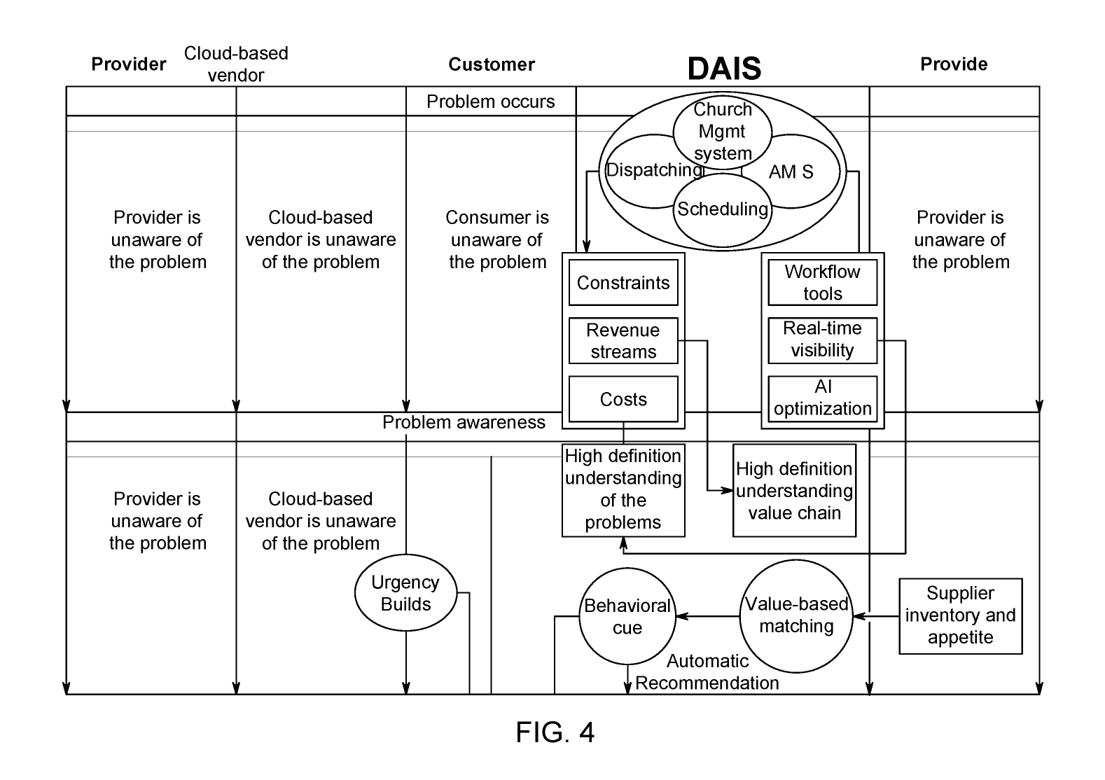

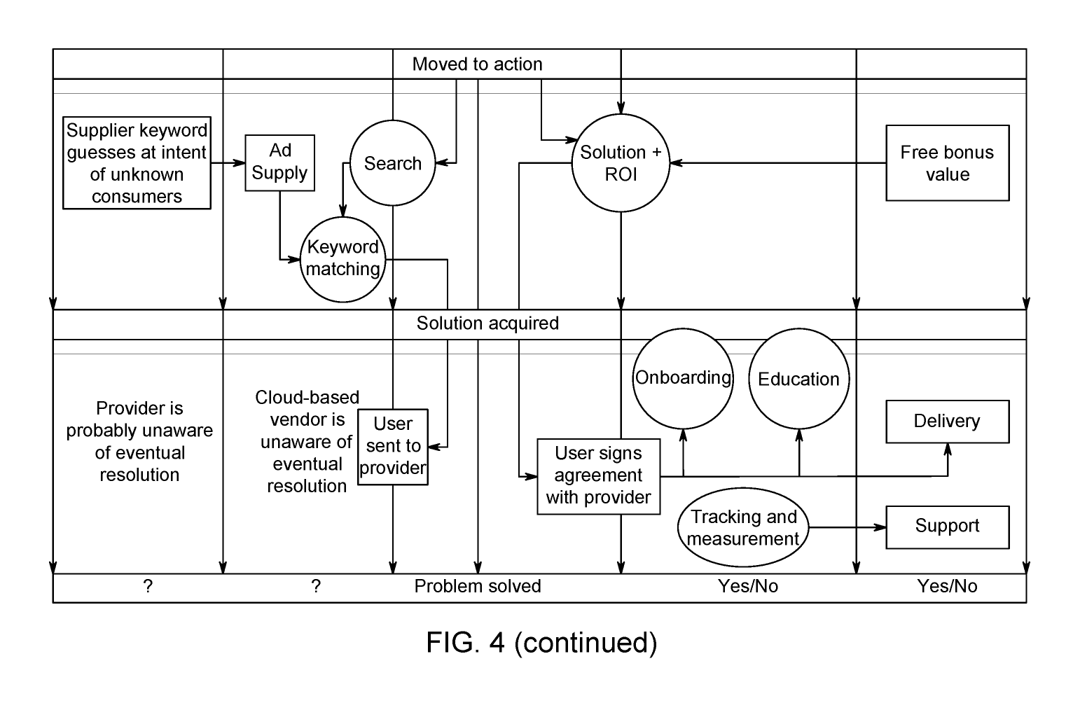

As shown in FIG. 4, the operational software can assist with onboarding and training new users for suppliers. The operational software can also observe the impact of the supplier's products on the operations of the user and the user's organization to measure the results against forecasted success metrics. By sharing results metrics with the supplier, the supplier is given opportunities to intervene to improve success probabilities. Further, with the business graph, parties are able to coordinate workflows to optimize efficiency. For example, if the user is filling a shipment, the supplier can be alerted about the status of the shipment.

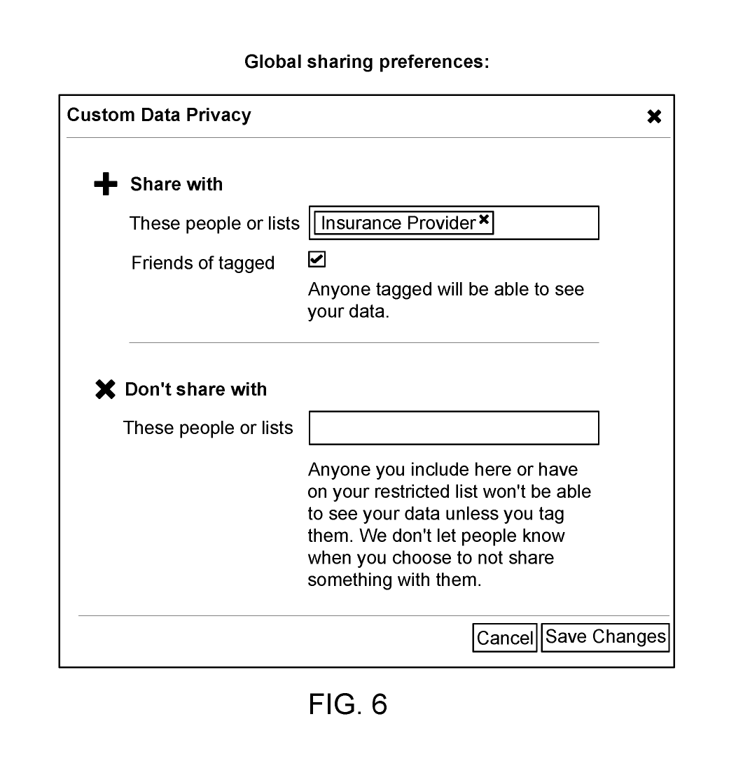

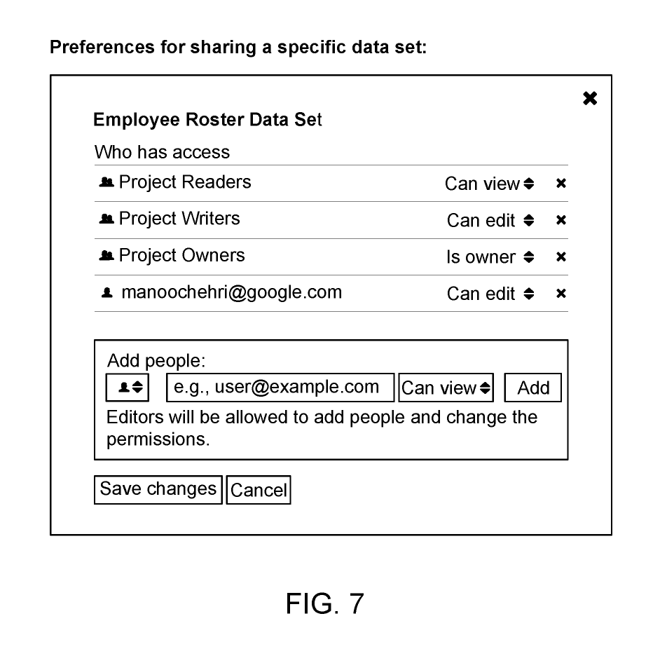

Operational data sharing is included in some implementations of this disclosure. When an operational data owner has decided to do business with a third party, the operational data owner initiates a flow of operational data to that third party. Similarly, when the operational data owner has decided to terminate a relationship with the third party, the user turns the flow of operational data off. Operational data sharing may be managed by an operational data sharing interface. The operational data sharing interface may involve global sharing preferences, where a user can determine, and/or select, for whom operational data is shared or made unavailable. A user can specify operational data sharing or blocking for individuals or groups of people and entities (see FIG. 6). Additionally, the operational data sharing interface may involve sharing preferences for specific portions of an operational data set (see FIG. 7). For example, a user can specify operational data sharing or blocking, for individuals or groups, for single or grouped portions of the total operational data. Such a customizable and controllable operational data sharing system allows providers to monitor business operations for changes relevant to their offering and can accordingly adjust pricing, make additional offers or alter service delivery.

In some implementations of the present disclosure, operational data owners can delegate authority to manage access to their operational data to a third party. The operational data sharing system can also include the ability to anonymize or mask specific operational data elements before they are shared, and operational data sharing conditions can include specific conditions for sharing operational data. One such condition could be, for example, sharing order details with an accounting partner only if a total order or account amount exceeds a certain threshold amount.

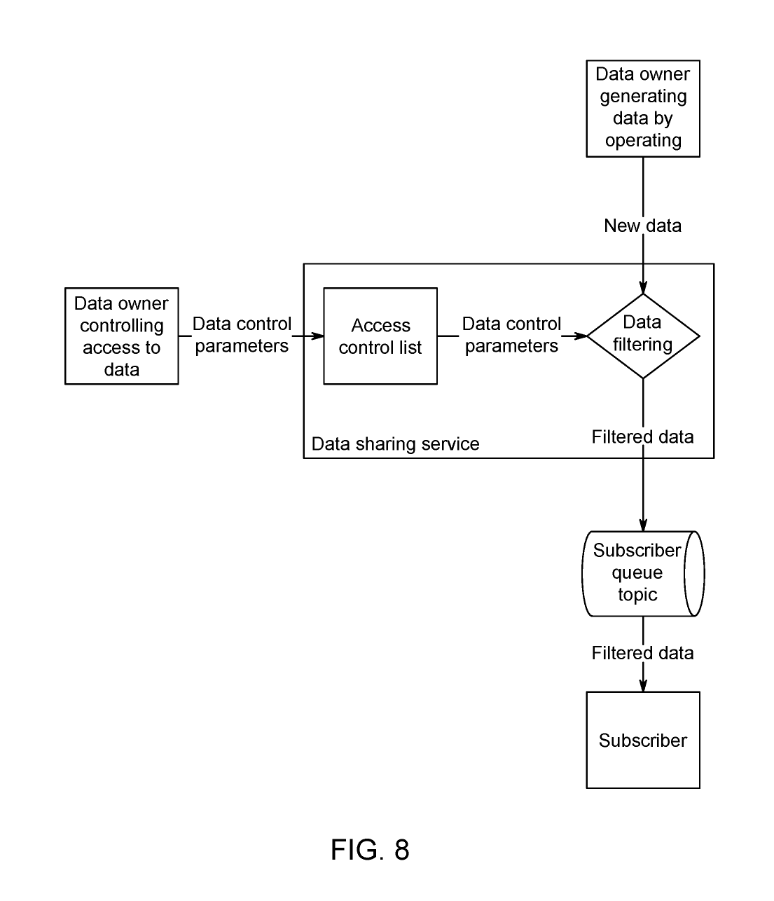

As shown in FIG. 8, implementations of the present disclosure may include a queue with a topic for each potential subscriber, where the operational data from owners who grant permission is sent for pickup by subscribers. Further, a user interface allows users to turn operational data sharing on and off with respect to different parties. An access control list is stored in an operational database and determines who a user would like to share operational data with. Additionally, an operational data sharing service is responsible for holding the access control list and using it to filter incoming operational data and distribute the incoming operational data to one or more subscriber queue topics.

The subject system offers numerous advantages over prior systems. For example, after a purchase is made, ongoing information can be shared with suppliers to ensure delivery variables are met and make adjustments to longer-running services such as finance or insurance. This gives suppliers an opportunity to intervene in potentially unsuccessful engagements or deployments. The disclosed system also provides businesses a chance to test multiple solutions for a given problem when outcomes are not satisfactory, and also includes an AB testing environment to assess multiple solutions simultaneously.

### Example System Architecture

Architecturally, the subject technology can be deployed anywhere. For example, it may be preferable to operate on a very powerful server, in particular one with parallel processing capabilities. When used in the cloud, the system may be deployed with a central database, which may leverage a network of other servers to spread the load of the system. Users (e.g., participants) may access the system either via a webpage or via an application programming interface (API) implemented within an existing system (e.g., within an on-demand system).

In one or more embodiments, the system may be deployed on a very powerful server, in particular one with parallel processing capabilities. Graphics cards may be used as optimizations for processing more operations in parallel. In one or more aspects, the generated workload may be optimally distributed across multiple different physical computers.

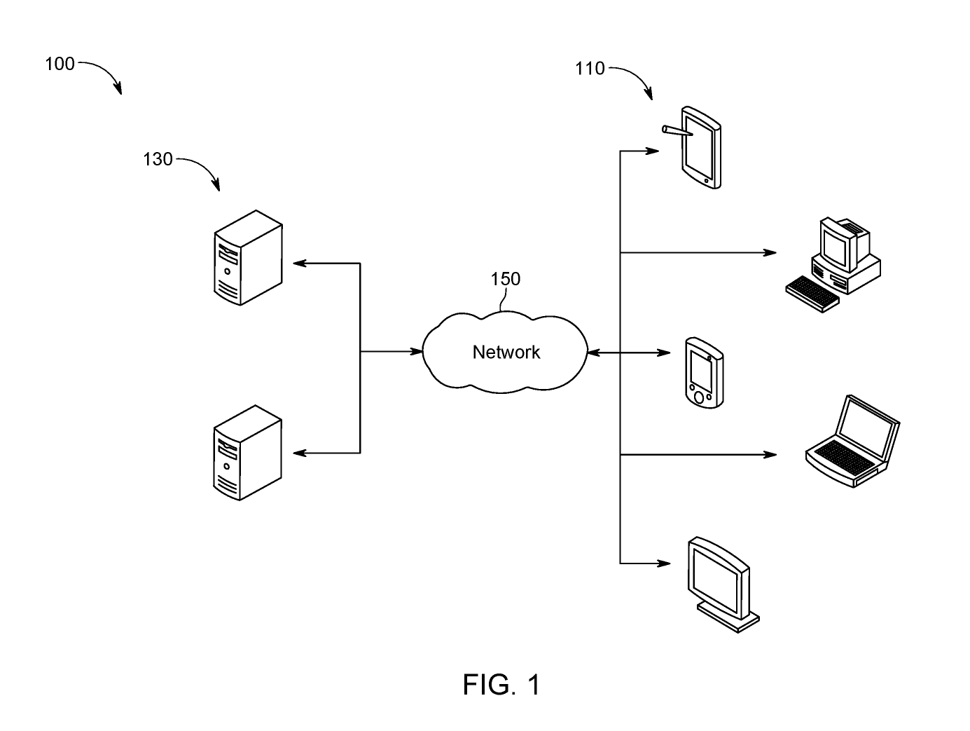

FIG. 1 illustrates an example architecture 100 for an operating system for an on-demand economy. The architecture 100 includes servers 130 and clients 110 connected over a network 150.

The clients 110 can be, for example, desktop computers, mobile computers, tablet computers (e.g., including e-book readers), mobile devices (e.g., a smartphone or personal digital assistant), set top boxes (e.g., for a television), video game consoles, or any other devices having appropriate processor, memory, and communications capabilities for querying, storing and/or analyzing data. The system provides interconnection of any combination of servers 130 and clients 110 over the network 150, stores on-demand economy related content on one or more databases on one or more servers 130, and processes the content to provide value data to various participants (e.g., quotes, leads, billing, payments, success metrics).

One or more of the many servers 130 are configured to analyze and/or process content and store the analysis/processing results in a database. The database may include, for each content item in the database, information on the relevance or weight of the content item with regards to user input received from a client 110. The database on the servers 130 can be queried by clients 110 over the network 150. For purposes of load balancing, multiple servers 130 can host the database either individually or in portions.

The servers 130 can be any device having an appropriate processor, memory, and communications capability for hosting any portion of the above-described on-demand economy related applications and databases. The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

In one or more embodiments, the system can be deployed on a distributed virtual machine and run by the network itself. In this case, for example, aspects of the operating system may be written to a blockchain and the network may execute various aspects of the operating system so that no single entity is in control of running the on-demand system.

### Example On-Demand Economy Operating System

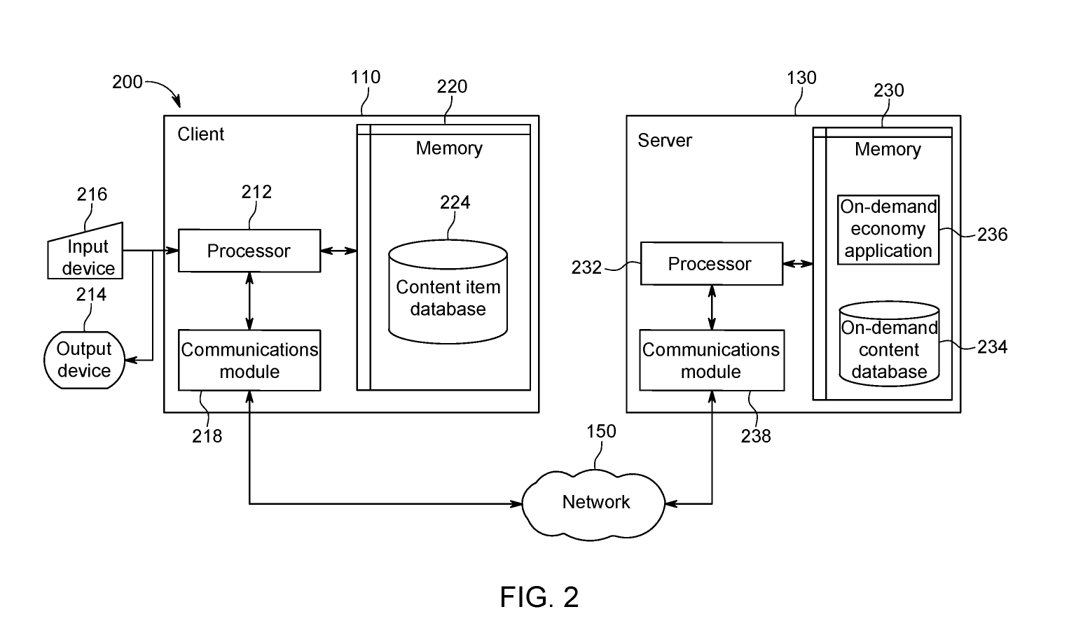

FIG. 2 is a block diagram 200 illustrating an example server 130 and client 110 in the architecture 100 of FIG. 1 according to certain aspects of the disclosure.

The client 110 and the server 130 are connected over the network 150 via respective communications modules 218 and 238. The communications modules 218 and 238 are configured to interface with the network 150 to send and receive information, such as data, requests, responses, tools and commands to other devices on the network. The communications modules 218 and 238 can be, for example, modems or Ethernet cards. The client 110 also includes an input device 216, such as a stylus, touchscreen, keyboard, or mouse, and an output device 214, such as a display. The server 130 includes a processor 232, the communications module 238, and a memory 230. The memory 230 includes an on-demand content database 234 and an on-demand economy application 236.

The client 110 further includes a processor 212, the communications module 218, and a memory 220. The memory 220 includes a content item database 224. The content item database 224 may include, for example, quotes, data access requests, out-of-band communications, billing information and support information, each which may be interacted with by a user of the client 110. The client 110 may be configured to initiate one or more user inputs related to a content item from the content item database 224, querying the on-demand content database 234 on the server 130 for additional content relevant to the user inputs, and receiving and storing relevant information (e.g., quotes) received from the on-demand economy application 236 on the server 130.

The processors 212, 232 of the client 110, server 130 are configured to execute instructions, such as instructions physically coded into the processor 212, 232 instructions received from software in memory 220, 230 or a combination of both. For example, the processor 212 of the client 110 may execute instructions to generate a query to the server 130 for content items based on user inputs, to receive content from the server 130, to store the received content in the content item database 224, and to provide the content for display on the client 110. The processor 232 of the server 130 may execute instructions to obtain new information from any participant of the system, to analyze/process the new information and store the results in the on-demand content database 234, to generate new content from the on-demand content database 234, and to provide relevant content to the client 110. The client 110 is configured to request and receive relevant content to/from the server 130 over the network 150 using the respective communications modules 218 and 238 of the client 110 and server 130.

Specifically, the processor 212 of the client 110 executes instructions causing the processor 212 to receive user input (e.g., using the input device 216) to generate a query out to other devices through the network 150 and to store received content data within the content item database 224. For example, the user may type in a request for specific product or service needs on the client 110, which then generates a query out to on-demand economy resources on the network 150.

The processor 232 of the server 130 may receive from the client 110 a set of user inputs to use in monitoring for new relevant content or as the basis for generating a direct response to the user query. The processor 232 of the server 130 may execute the on-demand economy application 236 over the inputs provided by the client. The processor 232 of the server 130 may then execute the on-demand economy application 236 to generate a quote, out-of-band communications and/or bills to the client 110.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

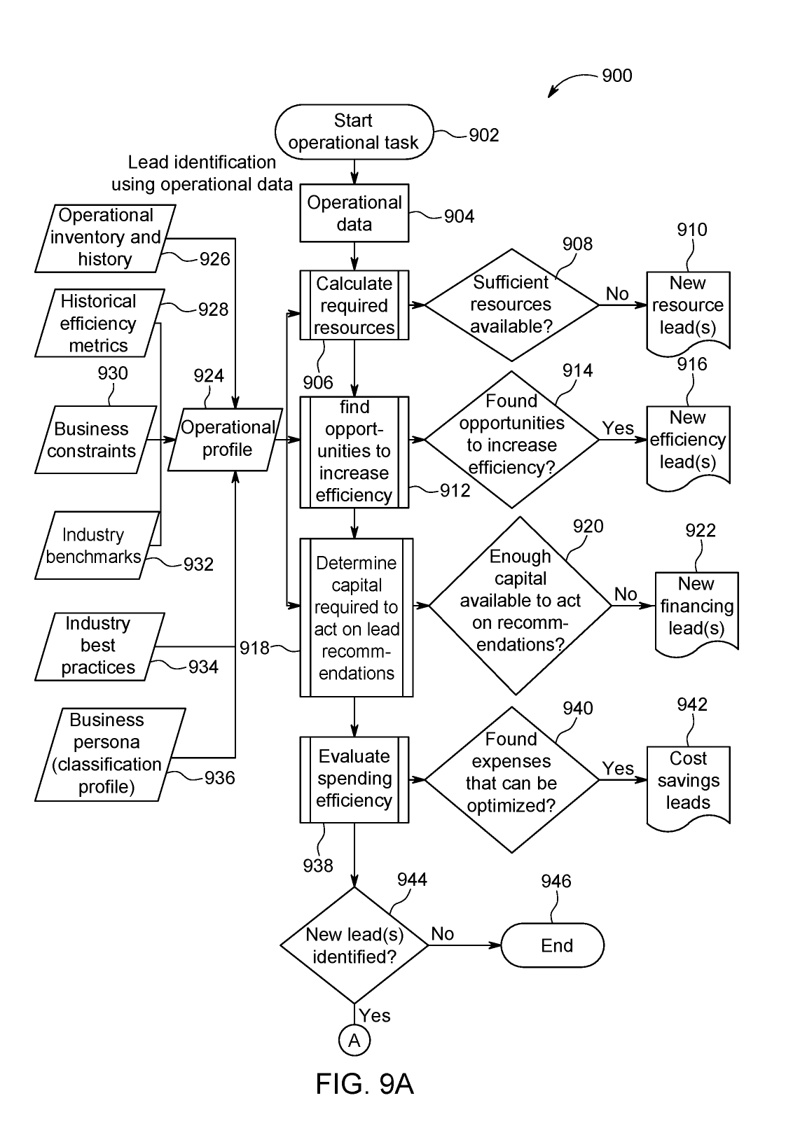

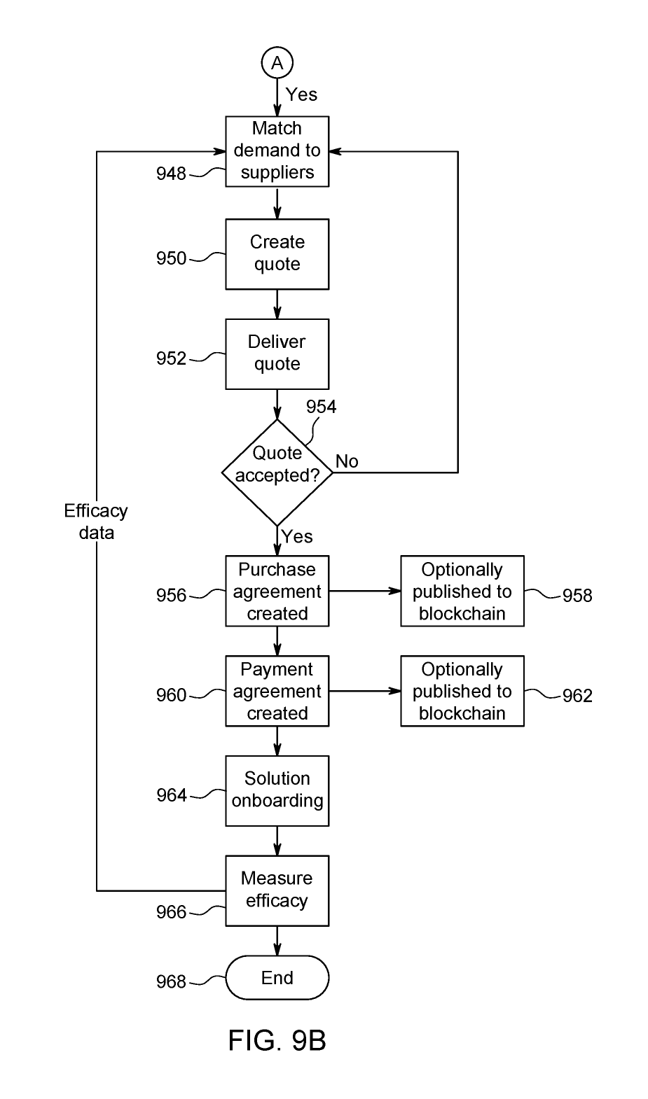

FIGS. 9-13 illustrate example processes 900-1300 of an on-demand economy operating system using the example server 130 of FIG. 2. While FIGS. 9-13 are described with reference to FIG. 2, it should be noted that the process steps of FIGS. 9-13 may be performed by other systems.

Regarding the on-demand system described above, in various embodiments the system provides for lead identification using operational data as illustrated in the example lead identification process 900 of FIG. 9. The process begins by starting an operational task in step 902 and then generating and/or receiving operational data in step 904. In step 906, the system calculates required resources. After determining if sufficient resources are available in step 908, the system generates new resource lead(s) in step 910 if sufficient resources are not available. In step 912, the system determines or finds opportunities to increase efficiency. If opportunities to increase efficiencies are found in step 914, the system generates/provides new efficiency lead(s) in step 916. In step 918, the system determines capital required to act on lead recommendations, and in step 920 the system determines if enough capital is available to act on the recommendations. If not enough capital is available, the system generates/provides new financing leads in step 922.

In step 924, an operational profile may be generated based on one or more input steps, such as receiving operational inventory and history 926, receiving historical efficiency metrics 928, receiving business constraints 930, receiving industry benchmarks 932, receiving industry best practices 934, and receiving business persona (e.g., classification profile) 936. In step 938, the system evaluates spending efficiency. If the system finds or determines expenses that can be optimized in step 940, the system provides cost savings leads in step 942. In step 944, the system determines if new lead(s) are identified. If new leads are not identified, the process ends at step 946.

If the system finds that new leads have been identified, then the system matches demand to suppliers in step 948. In step 950, the system creates a quote, and then the system delivers the quote in step 952. In step 952, the system determines if the quote is accepted. If the quote is not accepted, the process returns to step 948 to again match demand to suppliers. If the quote is accepted, the system creates a purchase agreement in step 956, which may by published to a blockchain in step 958. In step 960, a payment agreement is created, which may be published to the blockchain in step 962. Solution onboarding is generated by the system in step 964. In step 966, the system measures solution efficacy and the process ends in step 968. In one or more embodiments, the system may feed efficacy data from step 966 back to step 948 to assist in matching demand to suppliers.

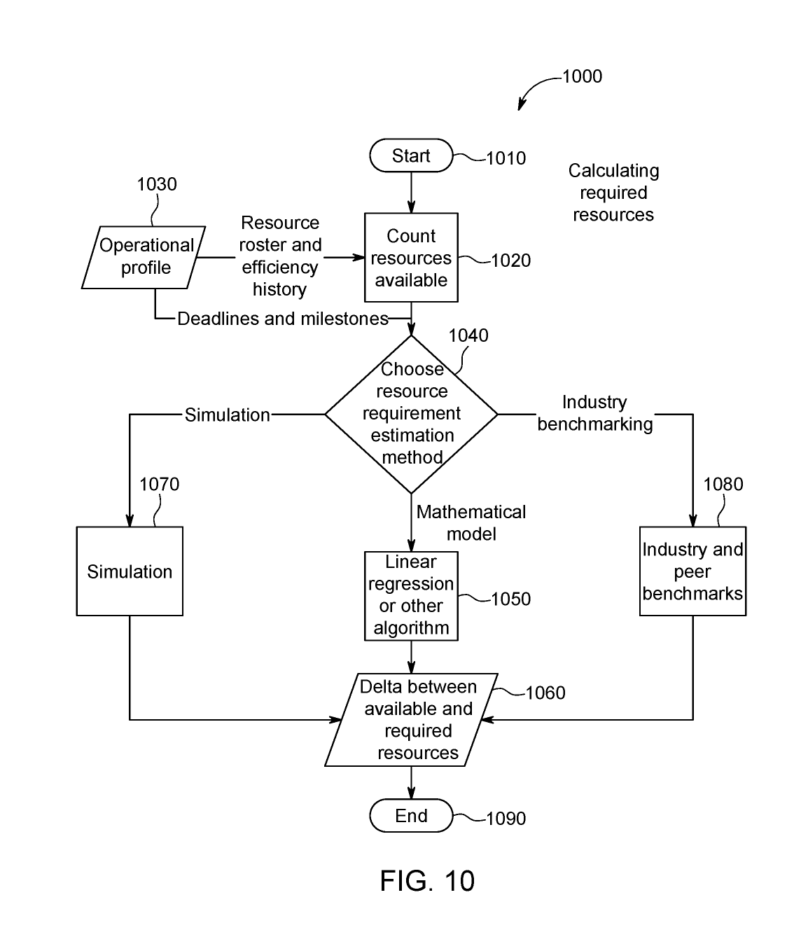

In FIG. 10, step 906 of calculating required resources is illustrated in process 1000, which begins in step 1010. In step 1020, the system counts resources that are available. Deadlines and milestones may be used to generate an operational profile in step 1030, which may then provide a resource roster and an efficiency history back to available resource counting step 1020. In step 1040, the system chooses or determines a resource requirement estimation method. If the method chosen is a mathematical model, the system uses a linear regression or other algorithm in step 1050. In step 1060, the delta is calculated between available and required resources based on the results of the mathematical model. If in step 1040, a simulation method is chosen, the system runs a simulation in step 1070. The simulation results are then fed into step 1060, which calculates the delta between available and required resources. Further, if an industry benchmarking method is chosen in step 1040, the system obtains industry and peer benchmarks in step 1080. Here as well, the results of the industry and peer benchmarks are fed into step 1060, which calculates the delta between available and required resources. The process ends in step 1090.

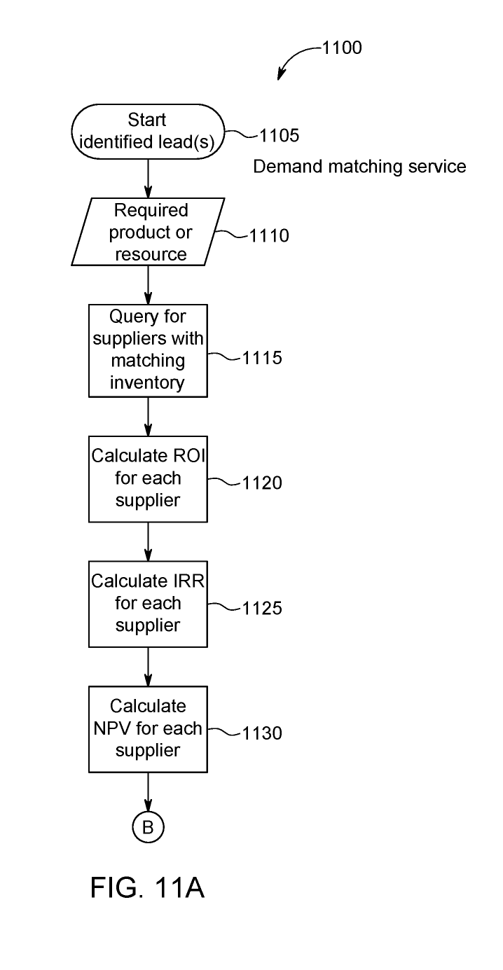

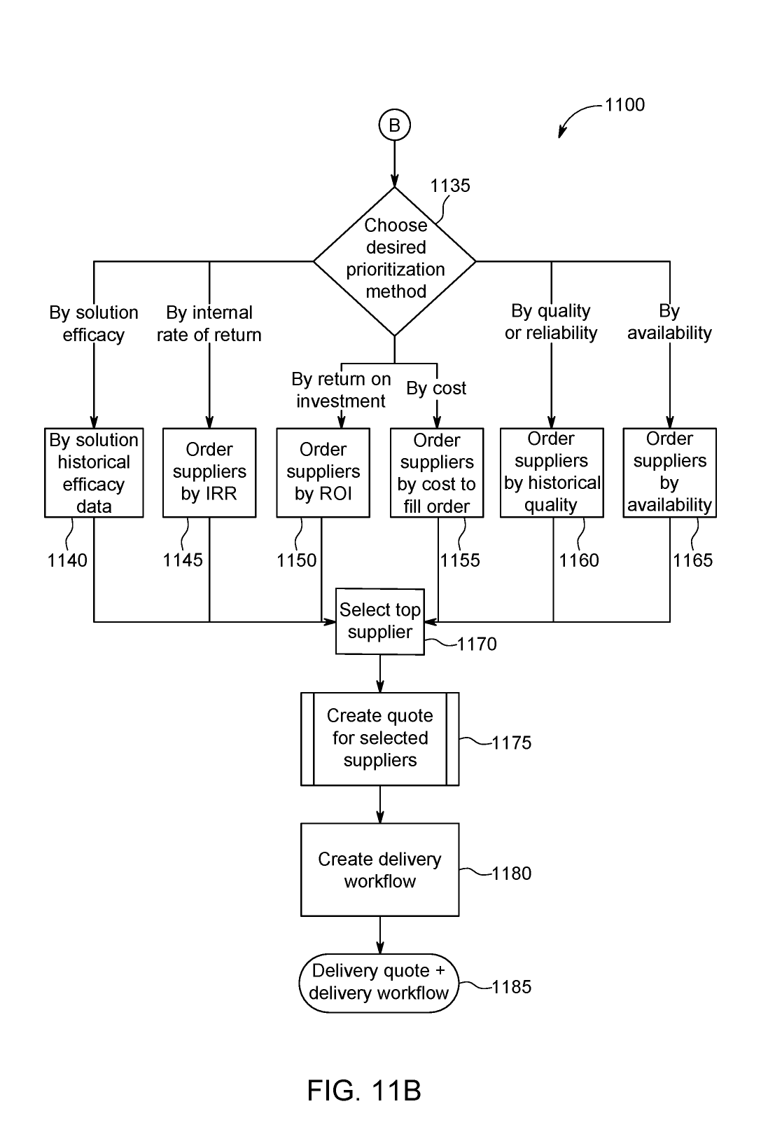

With regard to FIG. 11, step 944 of identifying new leads is illustrated in process 1100, which begins in step 1105. In step 1110, the system generates or obtains required products or resources. A query for suppliers with matching inventory is generated in step 1030, and the system calculates an ROI for each supplier in step 1120. In step 1125, the system calculates an IRR for each supplier, and calculates a net present value (NPV) for each supplier in step 1130. The system determines or chooses a prioritization method in step 1135.

If the prioritization method is by solution efficacy, the system analyzes solution historical efficacy date in step 1140. In step 1145, the system orders suppliers by IRR if the prioritization method is by IRR. If the prioritization method is by ROI, the system orders suppliers by ROI in step 1150. In step 1155, the system orders suppliers by the cost to fill the order if the prioritization method is by cost. If the prioritization method is by quality or reliability, the system orders suppliers by historical quality in step 1160. In step 1165, the system orders suppliers by availability if the prioritization method is by availability. Regardless of the prioritization method utilized, the system selects the top supplier in step 1170. In step 1175, the system creates a quote for the selected supplier, and creates a delivery workflow in step 1180. The process ends in step 1085 when the system delivers the quote and delivers workflow.

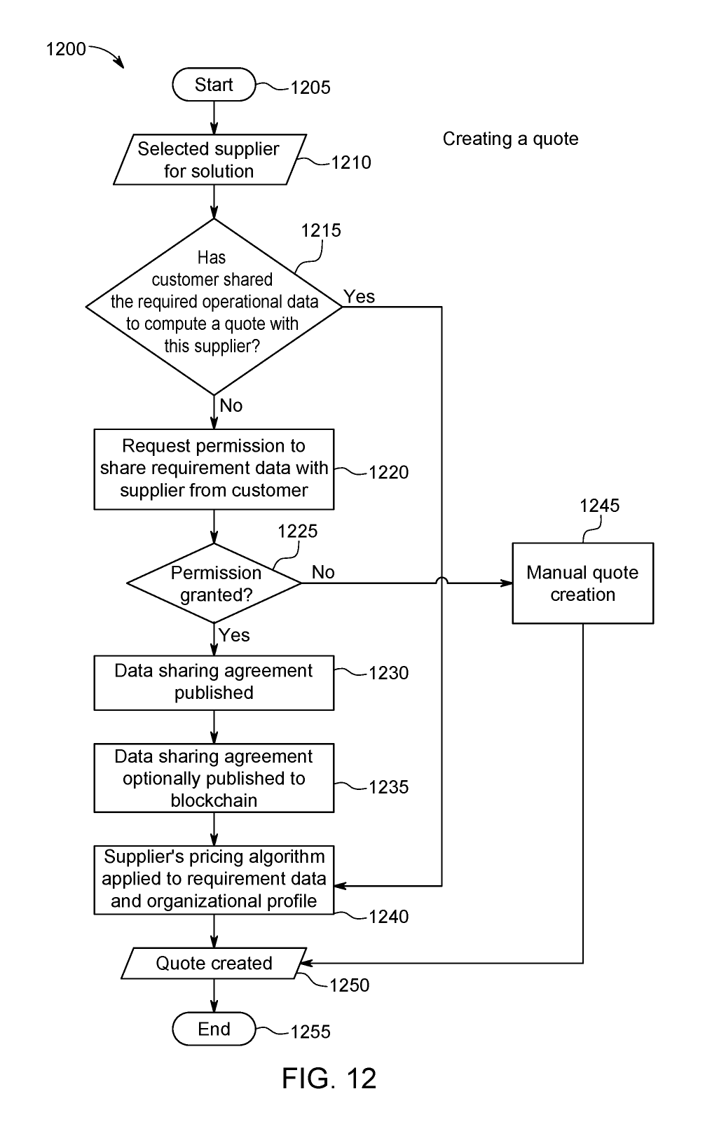

In FIG. 12, step 950 of creating a quote is illustrated in process 1200, which begins in step 1205. In step 1210, the system selects a supplier for the solution. The system determines whether a customer has shared the required operational data to compute a quote with the selected supplier in step 1215. If the answer is no, the system requests permission from the customer to share requirement data with the supplier in step 1220. In step 1225, the system determines whether permission is granted. If permission is granted, the system publishes a data sharing agreement in step 1230, which may be published to the blockchain in step 1235. In step 1240, the supplier's pricing algorithm is applied to the requirement data and to an organizational profile. If in step 1215, it is determined that the customer has shared the required operational data to compute a quote for the selected supplier, the process skips to applying the supplier's pricing algorithm in step 1240. If in step 1225, permission is not granted by the customer, the system proceeds to provide information for generating a manual quote in step 1245. In step 1250, the system creates a quote based on either the supplier's pricing algorithm of step 1240 or the manual quote information of step 1245. The process ends in step 1255.

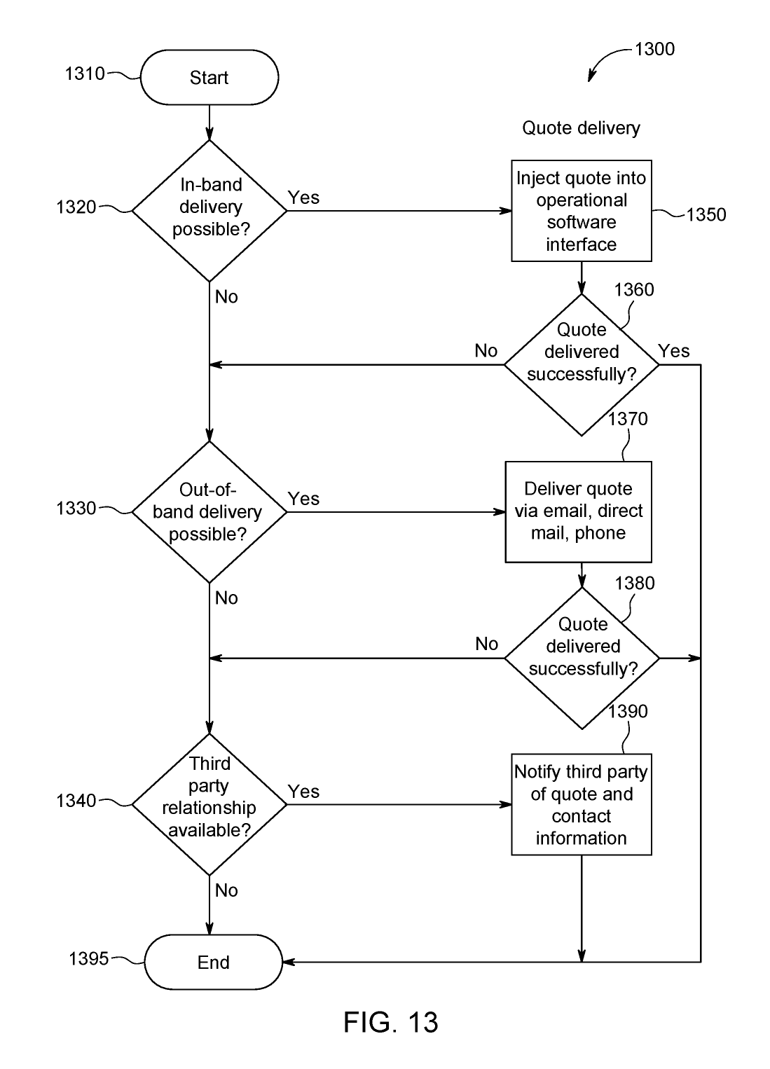

In FIG. 13, step 952 of delivering a quote is illustrated in process 1300, which begins in step 1310. In step 1320, the system determines if in-band delivery is possible. If in-band delivery is not possible, the system determines if out-of-band delivery is possible in step 1330. In step 1340, the system determines if a third party relationship is available if an out-of-band delivery is not possible. If in-band delivery is possible from step 1320, the system injects the created quote into an operational software interface in step 1350. In step 1360, the system then determines if the in-band quote was delivered successfully. If not, the process proceeds to step 1330 to determine if an out-of-band delivery is possible. If out-of-band delivery is possible from step 1330, the quote is delivered by an out-of-band process in step 1370. For example, the quote may be emailed, directly mailed or provided by telephone. In step 1380, the system then determines if the out-of-band quote was delivered successfully. If not, the process proceeds to step 1330 to determine if an out-of-band delivery is possible. If a third party relationship is available from step 1340, a third party is notified of the quote and contact information for the customer in step 1390. The process ends in step 1395 if the quote is delivered successfully in steps 1360 or 1380, the third party is notified of the quote and contact information in step 1390 or no third party relationship is available from step 1340.

An example will now be described using the example processes 900-1300 of FIGS. 9-13, a client 110 that has a smartphone having an output device 214 that is a flat panel display, an input device 216 that is a touch screen interface, a content item database 224 that stores content that can be displayed on the smartphone, and a communications module 218 that provides for communication between the smartphone client 110 and a network 150 of servers 130, with at least one server 130 having an on-demand content database 234 and an on-demand economy application 236. The on-demand economy application 236 may utilize a virtual machine operating on a blockchain. Alternately, it may utilize parallel processors in server 130, processors of multiple servers 130 and/or clients 110 over network 150, or a combination of both.

In one example, the process begins when the on-demand economy application 236 on a server 130 receives operational data to be processed. The operational data may be stored in the content item database 224, the on-demand content database 234 or on a blockchain. The on-demand economy application 236 then generates or obtains an operational profile based on one or more inputs (e.g., operational inventory/history, historical efficacy metrics, business constraints, industry benchmarks and/or best practices, business persona).

Continuing the example, the on-demand economy application 236 uses the operational profile to calculate required resources, determine potential efficiency increases and determine capital required to act on lead recommendations. For example, to calculate required resources, the on-demand economy application 236 counts available resources, chooses an estimation method (e.g., simulation, mathematical algorithm, benchmarks) and determines a delta between available and required resources. The on-demand economy application 236 further evaluates spending efficiency. The above-described calculations may result in any or all of new resource leads, new efficiency leads, new financing leads and cost saving leads. If no leads of any kind are generated, the process terminates and waits for receipt of new operational data.

If the on-demand economy application 236 generates new leads, it then proceeds to match demand to suppliers. For example, the on-demand economy application 236 uses the identified leads to establish the required product/resource, query for suppliers with matching inventory, calculate metrics for each supplier (e.g., ROI, IRR, NPV), select a top supplier based on a prioritization method (e.g., solution efficacy, IRR, ROI, cost, quality/reliability, availability) and create/deliver quote and delivery workflow.

Here, the on-demand economy application 236 creates and delivers a quote by determining whether an automated or manual quote process should be followed. For example, the automated process involves determining permission has been granted from the customer to share requirement data with the supplier, publishing the data sharing agreement (e.g., to the blockchain), and applying the supplier's pricing algorithm to automatically create a quote. Otherwise, when the customer's permission is not granted, the process is followed to manually generate a quote. Once a quote is generated, the quote is delivered in a chosen process. For example, the quote may be delivered in-band by being injected into an operational software interface that the customer utilizes or the quote may be delivered to the customer out-of-band using typical delivery sources (e.g., email, direct mail, telephone call). The quote, along with customer contact information, may be delivered to a third party (e.g., reseller, original equipment manufacturer (OEM), distributor, contractor) instead of the customer.

When the quote is accepted, the on-demand economy application 236 creates and publishes both purchase and payment agreements, which may be published to the blockchain, for example. The on-demand economy application 236 also proceeds with solution onboarding and efficacy measuring, looping the efficacy data back to the process of matching demand to suppliers. Similarly, if the quote is not accepted, the process loops back to matching demand to suppliers.

### Hardware Overview

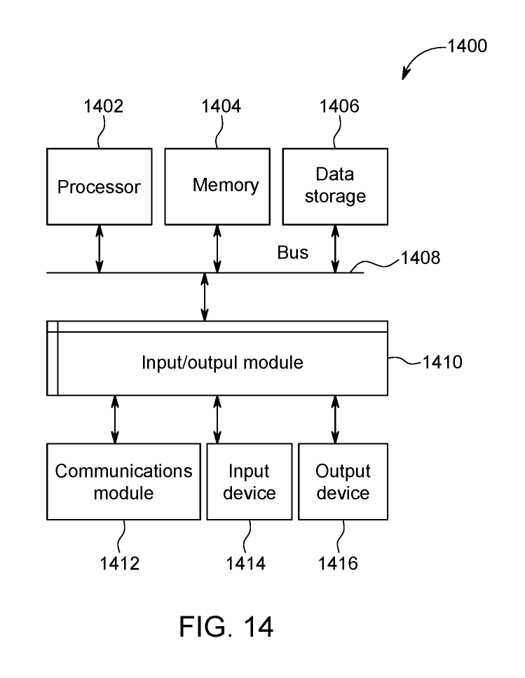

FIG. 14 is a block diagram illustrating an example computer system 1400 with which the client 110 and server 130 of FIG. 2 can be implemented. In certain aspects, the computer system 1400 may be implemented using hardware or a combination of software and hardware, either in a dedicated server or integrated into another entity or distributed across multiple entities.

Computer system 1400 (e.g., client 110 or server 130) includes a bus 1408 or other communication mechanism for communicating information, and a processor 1402 (e.g., processor 212 and 236) coupled with bus 1408 for processing information. According to one aspect, the computer system 1400 is implemented as one or more special-purpose computing devices. The special-purpose computing device may be hard-wired to perform the disclosed techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques. By way of example, the computer system 1400 may be implemented with one or more processors 1402. Processor 1402 may be a general-purpose microprocessor, a microcontroller, a Digital Signal Processor (DSP), an ASIC, a FPGA, a Programmable Logic Device (PLD), a controller, a state machine, gated logic, discrete hardware components, or any other suitable entity that can perform calculations or other manipulations of information.

Computer system 1400 can include, in addition to hardware, code that creates an execution environment for the computer program in question, e.g., code that constitutes processor firmware, a protocol stack, a database management system, an operating system, or a combination of one or more of them stored in an included memory 1404 (e.g., memory 220 and 230), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 1408 for storing information and instructions to be executed by processor 1402. The processor 1402 and the memory 1404 can be supplemented by, or incorporated in, special purpose logic circuitry. Expansion memory may also be provided and connected to computer system 1400 through input/output module 1410, which may include, for example, a SIMM (Single in Line Memory Module) card interface. Such expansion memory may provide extra storage space for computer system 1400 or may also store applications or other information for computer system 1400. Specifically, expansion memory may include instructions to carry out or supplement the processes described above and may include secure information also. Thus, for example, expansion memory may be provided as a security module for computer system 1400 and may be programmed with instructions that permit secure use of computer system 1400. In addition, secure applications may be provided via the SIMM cards, along with additional information, such as placing identifying information on the SIMM card in a non-hackable manner.

The instructions may be stored in the memory 1404 and implemented in one or more computer program products, i.e., one or more modules of computer program instructions encoded on a computer readable medium for execution by, or to control the operation of, the computer system 1400, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 1404 may also be used for storing temporary variable or other intermediate information during execution of instructions to be executed by processor 1402.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1400 further includes a data storage device 1406 such as a magnetic disk or optical disk, coupled to bus 1408 for storing information and instructions. Computer system 1400 may be coupled via input/output module 1410 to various devices. The input/output module 1410 can be any input/output module. Example input/output modules 1410 include data ports such as USB ports. In addition, input/output module 1410 may be provided in communication with processor 1402, so as to enable near area communication of computer system 1400 with other devices. The input/output module 1410 may provide, for example, for wired communication in some implementations, or for wireless communication in other implementations, and multiple interfaces may also be used. The input/output module 1410 is configured to connect to a communications module 1412. Example communications modules 1412 (e.g., communications modules 218 and 238) include networking interface cards, such as Ethernet cards and modems.

The components of the system can be interconnected by any form or medium of digital data communication, e.g., a communication network. The communication network (e.g., network 150) can include, for example, any one or more of a PAN, a LAN, a CAN, a MAN, a WAN, a BBN, the Internet, and the like. Further, the communication network can include, but is not limited to, for example, any one or more of the following network topologies, including a bus network, a star network, a ring network, a mesh network, a star-bus network, tree or hierarchical network, or the like.

For example, in certain aspects, communications module 1412 can provide a two-way data communication coupling to a network link that is connected to a local network. Wireless links and wireless communication may also be implemented. Wireless communication may be provided under various modes or protocols, such as GSM (Global System for Mobile Communications), Short Message Service (SMS), Enhanced Messaging Service (EMS), or Multimedia Messaging Service (MMS) messaging, CDMA (Code Division Multiple Access), Time division multiple access (TDMA), Personal Digital Cellular (PDC), Wideband CDMA, General Packet Radio Service (GPRS), or LTE (Long-Term Evolution), among others. Such communication may occur, for example, through a radio-frequency transceiver. In addition, short-range communication may occur, such as using a BLUETOOTH, WI-FI, or other such transceiver.

In any such implementation, communications module 1412 sends and receives electrical, electromagnetic or optical signals that carry digital data streams representing various types of information. The network link typically provides data communication through one or more networks to other data devices. For example, the network link of the communications module 1412 may provide a connection through local network to a host computer or to data equipment operated by an Internet Service Provider (ISP). The ISP in turn provides data communication services through the world wide packet data communication network now commonly referred to as the Internet. The local network and Internet both use electrical, electromagnetic or optical signals that carry digital data streams. The signals through the various networks and the signals on the network link and through communications module 1412, which carry the digital data to and from computer system 1400, are example forms of transmission media.

Computer system 1400 can send messages and receive data, including program code, through the network(s), the network link and communications module 1412. In the Internet example, a server might transmit a requested code for an application program through Internet, the ISP, the local network and communications module 1412. The received code may be executed by processor 1402 as it is received, and/or stored in data storage 1406 for later execution.

In certain aspects, the input/output module 1410 is configured to connect to a plurality of devices, such as an input device 1414 (e.g., input device 216) and/or an output device 1416 (e.g., output device 214). Example input devices 1414 include a stylus, a finger, a keyboard and a pointing device, e.g., a mouse or a trackball, by which a user can provide input to the computer system 1400. Other kinds of input devices 1414 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 1416 include display devices, such as a LED (light emitting diode), CRT (cathode ray tube), LCD (liquid crystal display) screen, a TFT LCD (Thin-Film-Transistor Liquid Crystal Display) or an OLED (Organic Light Emitting Diode) display, for displaying information to the user. The output device 1416 may comprise appropriate circuitry for driving the output device 1416 to present graphical and other information to a user.

According to one aspect of the present disclosure, the client 110 and server 130 can be implemented using a computer system 1400 in response to processor 1402 executing one or more sequences of one or more instructions contained in memory 1404. Such instructions may be read into memory 1404 from another machine-readable medium, such as data storage device 1406. Execution of the sequences of instructions contained in main memory 1404 causes processor 1402 to perform the process steps described herein. One or more processors in a multi-processing arrangement may also be employed to execute the sequences of instructions contained in memory 1404. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components.

Computing system 1400 can include clients and servers. A client and server are generally remote from each other and typically interact through a communication network. The relationship of client and server arises by virtue of computer programs running on the respective computers and having a client-server relationship to each other. Computer system 1400 can be, for example, and without limitation, a desktop computer, laptop computer, or tablet computer. Computer system 1400 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer-readable medium” as used herein refers to any medium or media that participates in providing instructions or data to processor 1402 for execution. The term “storage medium” as used herein refers to any non-transitory media that store data and/or instructions that cause a machine to operate in a specific fashion. Such a medium may take many forms, including, but not limited to, non-volatile media, volatile media, and transmission media. Non-volatile media include, for example, optical disks, magnetic disks, or flash memory, such as data storage device 1406. Volatile media include dynamic memory, such as memory 1404. Transmission media include coaxial cables, copper wire, and fiber optics, including the wires that comprise bus 1408. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

As used in this specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire and fiber optics, including the wires that comprise bus 1408. Transmission media can also take the form of acoustic or light waves, such as those generated during radio-wave and infra-red data communications. Furthermore, as used in this specification of this application, the terms “computer”, “server”, “processor”, and “memory” all refer to electronic or other technological devices. These terms exclude people or groups of people. For the purposes of the specification, the terms display or displaying means displaying on an electronic device.

In one aspect, a method may be an operation, an instruction, or a function and vice versa. In one aspect, a clause or a claim may be amended to include some or all of the words (e.g., instructions, operations, functions, or components) recited in either one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method for matching supply and demand in an on-demand economy, the method comprising:
obtaining, by one or more processors, operational data and operational profile inputs;
determining, by one or more processors, at least one driver for generating leads based on the operational data and operational profile inputs;
generating, by one or more processors, at least one lead;
matching, by one or more processors, demand based on the at least one lead to one or more suppliers;
creating, by one or more processors, a quote covering a product or service;
delivering, by one or more processors, the quote to a device of a user;
generating, by one or more processors, a purchase agreement and a payment agreement upon acceptance of the quote;
measuring, by one or more processors, efficacy of the above process; and
generating, by one or more processors, efficacy data to be used in a next iteration of matching demand to suppliers.

2. The method of claim 1, further comprising:
reiterating the step of matching demand to suppliers if the quote is not accepted.

3. The method of claim 1, further comprising:
generating the operation profile based on one or more of operational inventory and history, historical efficacy metrics, business constraints, industry benchmarks, industry best practices and a classification profile.

4. The method of claim 1, the determining at least one driver comprising:
calculating required resources;
determining whether sufficient resources are available; and
generating a new resource lead if sufficient resources are not available.

5. The method of claim 4, the calculating required resources comprising:
determining available resources;
choosing a resource requirement estimation method; and
calculating a delta between available and required resources.

6. The method of claim 5, wherein the resource requirement estimation method comprises one of a simulation, a mathematical algorithm, industry benchmarks and peer benchmarks.

7. The method of claim 1, the matching demand to the one or more suppliers comprising:
generating a supplier query for matching inventory to a product or service identified in the at least one lead;
calculating metric data for each supplier;
choosing a prioritization method;
selecting a supplier based on the chosen prioritization method;
creating a quote for a selected supplier;
creating delivery workflow; and
delivering the created quote and delivery workflow to the selected supplier.

8. The method of claim 7, wherein the metric data calculated for each supplier is at least one of return on investment, internal rate of return and net present value.

9. The method of claim 7, wherein the prioritization method comprises one of solution efficacy, return on investment, internal rate of return, cost to fill order, historical quality and availability.

10. The method of claim 1, the creating a quote comprising:
determining that required operational data to compute a quote with a selected supplier has been shared by the user;
applying a pricing algorithm from the selected supplier requirement data and an organizational profile; and
generating an automated quote.

11. The method of claim 1, the creating a quote comprising:
determining that required operational data to compute a quote with a selected supplier has not been shared by the user;
requesting permission to share customer requirement data with the selected supplier; and
generating a manual quote if permission is not granted.

12. The method of claim 1, the creating a quote comprising:
determining that required operational data to compute a quote with a selected supplier has not been shared by the user;
requesting permission to share customer requirement data with the selected supplier;
determining permission has been granted;
publishing a data sharing agreement;
applying a pricing algorithm from the selected supplier requirement data and an organizational profile; and
generating an automated quote.

13. The method of claim 12, wherein the data sharing agreement is published to a blockchain.

14. The method of claim 1, the delivering a quote comprising:
determining if in-band delivery is feasible;
injecting the quote into an operational software interface if in-band delivery is feasible; and
determining if the quote was delivered successfully.

15. The method of claim 14, further comprising:
determining if out-of-band delivery is feasible if the in-band delivery is one of not feasible and not successfully delivered;
delivering the quote by out-of-band delivery if out-of-band delivery is feasible; and
determining if the quote was delivered successfully.

16. The method of claim 15, further comprising:
determining if a third party relationship is available if the out-of-band delivery is one of not feasible and not successfully delivered; and
providing the quote and contact information to a third party if the third party relationship is available.

17. An on-demand economy operating system for efficiently matching supply and demand, comprising:
an operational software module configured to provide an interface to one or more user devices;
a supplier module configured to provide an interface to one or more supplier devices;
a demand identification service module configured to identify needs in operational data;
an exchange service module configured to catalogue supply, negotiate purchase agreements and negotiate bills;
a demand matching service module configured to incorporate leads from the demand identification service module, to incorporate pricing and inventory information from the exchange service module, and to match supply with demand; and
a data sharing service module configured to track user agreements and to share data with third parties.

18. An on-demand economy operating system, the system comprising:
a memory; and
a processor configured to execute instructions which, when executed, cause the processor to:
obtain operational data and operational profile inputs;
determine at least one driver for generating leads based on the operational data and operational profile inputs;
generate at least one lead;
match demand based on the at least one lead to one or more suppliers;
create a quote covering a product or service;
deliver the quote to a device of a user;
generate a purchase agreement and a payment agreement upon acceptance of the quote;
determine efficacy of the above process; and
generate efficacy data to be used in a next iteration of matching demand to suppliers.

19. The system of claim 18, further comprising instructions that cause the processor to:
calculate required resources by determining available resources, choosing a resource requirement estimation method and calculating a delta between available and required resources;
determine whether sufficient resources are available; and
generate a new resource lead if sufficient resources are not available.

20. The system of claim 18, further comprising instructions that cause the processor to:
generate a supplier query for matching inventory to a product or service identified in the at least one lead;
calculate metric data for each supplier, the metric data comprising at least one of return on investment, internal rate of return and net present value;
choose a prioritization method;
select a supplier based on the chosen prioritization method;
create a quote for a selected supplier;
create delivery workflow; and
deliver the quote and delivery workflow to the selected supplier.
